(19) United States
(12) Patent Application Publication
(10) Pub. No.: US 2026/0347198 A1
(43) Pub. Date: Nov. 5, 2026

(54) PROCESS AND PLANT FOR PRODUCING AMMONIA

(71) Applicant: GASCONTEC GMBH, Höhe (DE)

(72) Inventors: Ulrich Wagner, Bernburg (DE); Dorit Rappold, Frankfurt (DE); Wolfgang Lauer, Schwalmstadt (DE)

(21) Appl. No.: 19/487,940

(22) PCT Filed: May 24, 2024
(86) PCT No.: PCT/EP2024/064345

§ 371 Date: Nov. 25, 2025

(30) Foreign Application Priority Data
May 26, 2023 (EP) 23175674.3

(51) Int. Cl. C01C 1/04; C01B 3/025; C01B 3/382; C01B 3/48; C01B 3/52

(52) U.S. Cl. CPC C01C 1/0405; C01B 3/025; C01B 3/382; C01B 3/48; C01B 3/52; C01B 2203/0244; C01B 2203/0288; C01B 2203/0415; C01B 2203/0475; C01B 2203/068; C01B 2203/142

(57) ABSTRACT

In an embodiment a method for producing ammonia in a plant includes feeding a carbon-containing energy carrier stream to a syngas reactor arrangement for obtaining a syngas stream with hydrogen and carbon oxides, wherein the syngas reactor arrangement obtains the syngas stream from the energy carrier stream by autothermal reforming, feeding the syngas stream to a shifting apparatus, wherein a water-gas shift reaction takes place in the shifting apparatus to react at least a part of carbon monoxide of the syngas stream with steam from the syngas stream to yield carbon dioxide and hydrogen, and feeding at least part of the syngas stream to a separating arrangement downstream of the shifting apparatus for separating the syngas stream at least into a hydrogen stream with hydrogen and a waste gas stream containing carbon oxides, and feeding at least a part of the hydrogen stream and a nitrogen stream to an ammonia reactor arrangement to convert into the ammonia.

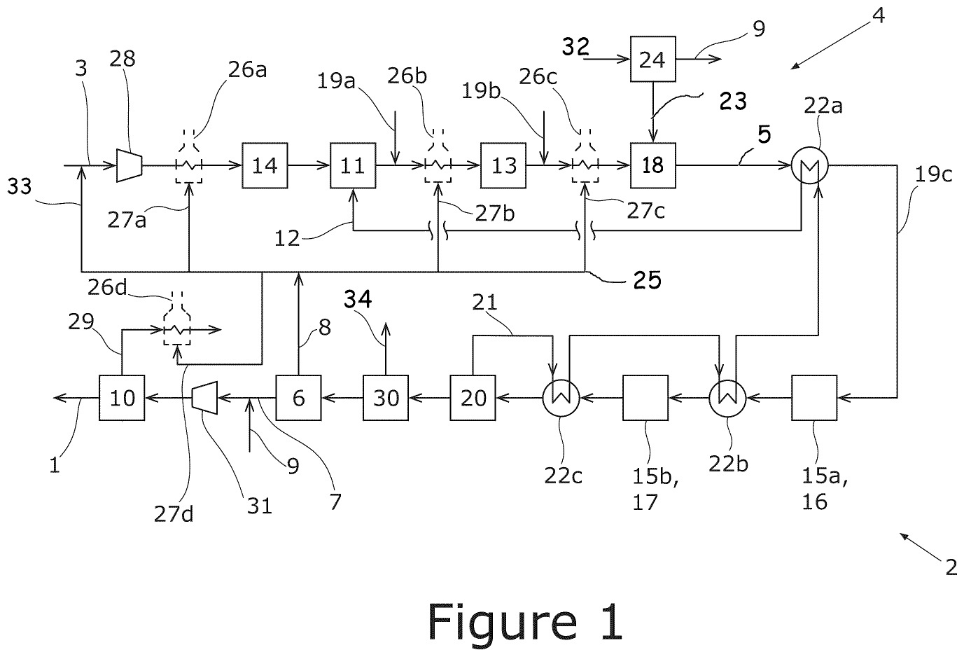

### CROSS-REFERENCE TO RELATED APPLICATIONS

This patent application is a national phase filing under section 371 of PCT/EP2024/064345, filed May 24, 2024, which claims the priority of European patent application no. 23175674.3, filed May 26, 2023, each of which is incorporated herein by reference in its entirety.

### TECHNICAL FIELD

The invention relates to a process for producing ammonia.

### BACKGROUND

Ammonia is a substance that is becoming more and more important as a medium for transporting hydrogen. The main reason for this is that it can be transported more easily and more economically in terms of energy than just transporting pure hydrogen and can also be separated into its constituent elements nitrogen and hydrogen again very simply.

In this context, there has been greater focus on producing ammonia in a way that has a very small CO2 footprint. Specifically with reference to a “low-low carbon footprint”, the terms “blue” hydrogen and “blue” ammonia are then also used.

Production of ammonia begins with hydrogen and nitrogen as precursor materials, wherein particularly the hydrogen is provided regularly by syngas, said syngas being obtained from a carbon-containing energy carrier stream such as natural gas. An ultrapure hydrogen stream can then be obtained from the syngas by PSA, for example. The use of PSA prevents impurities in the gas that is used for ammonia synthesis, thereby rendering corresponding purification procedures for synthesising ammonia unnecessary. Essential processes in the production of ammonia that lead to the emission of carbon dioxide firstly include the decomposition of atmospheric air to recover the nitrogen. This decomposition requires a certain amount of energy, which can also be a cause of CO2 emission into the atmosphere.

Secondly, obtaining the syngas also requires energy, wherein particularly when a steam reformer is used for this purpose, up to 30% of the natural gas used is needed to underfire it. The CO2 contained in the flue gas at this point is discharged into the atmosphere. CO2 that collects otherwise int the process can be separated by scrubbing and used or sequestered without the need for discharging into the atmosphere.

The quantity of CO2 emitted in the flue gas corresponding to about 10% of the natural gas utilised can be reduced by using autothermal reforming (ATR) exclusively instead of steam reforming to generate the syngas. Such autothermal reforming from the prior art is disclosed for example in US 2020/0055738 A1, assigned to Casale S. A., which is considered the closest prior art for the purpose of the present invention. With autothermal reforming, in which the required temperature is created by catalytic partial oxidation, it is not necessary to supply external heat in order to generate the syngas, at most all that is needed is to preheat the energy carrier stream with a gas-fired raw material heater (“fired heater”) before it is fed to autothermal reforming. Furthermore, the air fractionation, which is beneficial for autothermal reforming anyway, can also serve at the same time to provide nitrogen for ammonia synthesis.

Very low emission values are already achieved by using the off-gas from PSA, which is produced when separating the syngas into hydrogen and off-gas, for the essential preheating of the syngas before ATR. The remaining energy difference is balanced out with desulphurised natural gas.

As described in the previously cited US 2020/0055738 A1 decarbonised syngas can also be used in the fired heaters to reduce CO2 emissions. However, this is contingent on the implementation of highly effective CO2 scrubbing; otherwise the CO2 in the syngas that has not yet been separated increases the residual emission again. Moreover, it is still necessary to subject the decarbonised syngas to further processing before the ammonia synthesis, since in particular methane from the methane slip from the ATR, which gets into the ammonia synthesis circuit in the technical solution according to US 2020/0055738 A1, constitutes most of the CO2 emission after combustion in the fired heaters. But even this processing cannot entirely prevent the methane from getting into the off-gas one way or another. It is thus not possible to reduce the residual emissions below the target value of 0.2 t CO2 per t ammonia.

Even firing the fired heaters with previously produced ultrapure hydrogen does not prevent methane from appearing in the off-gas. And of course it is not effective to configure a PSA for the highest degree, only to then combust the ultrapure hydrogen produced a second time.

### SUMMARY

Embodiments of the invention provide an improved approach for the production of ammonia with a very small CO2 footprint.

Embodiments of the invention are based on the finding that the overall quantity of emitted CO2 in a plant for synthesising ammonia with autothermal reforming may surprisingly be reduced by feeding process condensate, which is generated in the process and preheated with process waste heat, via a saturation stage to the natural gas, which is also preheated, which in turn raises the molar steam-to-carbon-ratio (S/C ratio) in the ATR. The use of process condensate in a saturation stage instead of feeding high-pressure steam results in savings in terms of the energy that would be needed to produce the high-pressure steam. Another benefit of increasing the molar S/C ratio is that the quantity of steam produced in the overall process is sufficient to enable the plant to be operated without the need to import electricity and to avoid producing additional high-pressure steam. In addition, on the one hand the methane slip is reduced significantly, with the result that the carbon from the methane in the synthesis gas stream prevented in this way, which is then present as CO2, can be removed from the process circuit by CO2 scrubbing and is subsequently not released into the atmosphere. On the other hand, the higher S/C ratio also causes the reaction equilibrium in a subsequent water-gas shift reaction of the syngas to shift towards carbon dioxide, thereby reducing the proportion of carbon monoxide in the syngas. Consequently, this also reduces the CO2 emissions, as the carbon dioxide obtained via the shift reaction can be washed out, and the hydrogen that is also recovered can be used either for the ammonia synthesis or for the CO2-free underfiring of the fired heaters. It is particularly advantageous if enough condensate can be supplied via the saturator before the ATR to establish the optimum steam-to-C ratio for the shift reaction.

The preferred embodiments relate to the capability of carrying out the water-gas shift reaction in multiple stages, each with different temperature ranges, thereby making it possible to achieve particularly thorough conversion of carbon monoxide into carbon dioxide, which can then be washed out of the syngas.

The preferred embodiments relate to advantageous measures for obtaining process condensate in the plant.

Finally, the preferred embodiments show how the adsorption apparatus can be operated in such a way as to enable enough hydrogen to be obtained to operate the fired heaters, thus rendering the use of natural gas unnecessary.

### BRIEF DESCRIPTION OF THE DRAWINGS

Further details, features, variants, objectives and advantages of the present invention will be explained in the following text with reference to drawing, which illustrates only exemplary embodiments thereof.

The FIGURE is a schematic flow diagram of an exemplary embodiment of a suggested plant for performing the suggested process.

### DETAILED DESCRIPTION OF ILLUSTRATIVE EMBODIMENTS

The suggested process is used to produce ammonia 1 in a plant 2 for producing ammonia 1. In the suggested process, a carbon-containing energy carrier stream 3 is fed to a syngas reactor arrangement 4 for obtaining a syngas stream 5 with hydrogen and carbon oxides, wherein the syngas reactor arrangement 4 obtains the syngas stream 5 from the energy carrier stream 3 by autothermal reforming. In this context, particularly a catalytic partial oxidation supplies the heat required for the endothermal reforming reactions. In particular, the syngas reactor arrangement 4 may be equipped with a syngas reactor stage 18 for obtaining the syngas stream 5. The plant 2 preferably comprises the syngas reactor arrangement 4. The energy carrier stream 3 preferably contains natural gas or even consists substantially of natural gas.

In the suggested process, the syngas stream 5 is fed to a shifting apparatus 15a-b, wherein a water-gas shift reaction takes place in the shifting apparatus 15a-b to react at least part of the carbon monoxide in the syngas stream 5 with steam in the syngas stream 5 to yield carbon dioxide and hydrogen. The syngas stream 5 thus evidently contains water.

Also in the suggested process, at least a part of the syngas stream 5 is fed to a separating arrangement 6 downstream of the shifting apparatus 15a-b for separating the syngas stream 5 at least into a hydrogen stream 7 with hydrogen and a waste gas stream 8 containing carbon oxides, wherein at least part of the hydrogen stream 7 is fed together with a nitrogen stream 9 to an ammonia reactor arrangement 10, where it is converted into ammonia 1. In other words, the syngas stream 5 is fed to the separating arrangement 6 after it has been fed to the shifting apparatus 15a-b. In this context, it is not necessary, and here also not the case, that the syngas stream 5 is fed to the separating arrangement 6 immediately downstream of the shifting apparatus 15a-b for process engineering purposes. In particular, a carbon dioxide scrubbing apparatus 30, which is described in greater detail later on, is provided between the shifting apparatus 15a-b and the separating arrangement 6. This means that at least part of the hydrogen stream 7 is fed to the ammonia reactor arrangement 10. It may be that more than one hydrogen stream 7 and possibly further streams are obtained from the separating arrangement 6 by separation of the syngas stream 5. In this case, the further hydrogen streams may also be fed entirely or partially to the ammonia reactor arrangement 10. The plant 2 preferably comprises the separating arrangement 6, the shifting apparatus 15a-b and/or the ammonia reactor arrangement 10.

The hydrogen stream 7 and the nitrogen stream 9 are preferably merged and subsequently fed to the ammonia reactor arrangement 10. In particular, an ammonia-syngas compressor 31 of plant 2 may be provided in order to increase the pressure of the hydrogen stream 7 and the nitrogen stream 9, preferably together.

Autothermal reforming has the advantage, among others, that it results in a highly pressurised syngas stream 5. It is therefore preferable that the syngas stream 5 is transported from the syngas reactor arrangement 4 to the separating arrangement 6 without increased pressurisation. In other words, the syngas stream 5 is not subjected to increased pressurisation between the syngas reactor arrangement 4 and the separating arrangement 6, meaning that the considerable costs of a compressor stage can be dispensed with.

The separating arrangement 6 may comprise different types of apparatuses. According to a first option, the separating arrangement 6 comprises an adsorption apparatus for separating hydrogen, which may in particular—as in the present embodiment—be a pressure swing adsorption apparatus or a temperature swing adsorption apparatus. Alternatively or additionally, the separating arrangement may also include a membrane apparatus for separating hydrogen.

The suggested process is characterized in that, prior to being fed to the syngas reactor arrangement 4, the energy carrier stream 3 is fed to a saturation stage 11, in which saturation stage 11 preheated condensate 12 that has arisen in the plant 2 is fed to the energy carrier stream 3.

The suggested process is further characterized in that at least 80% of a steam fraction of the syngas stream 5 is already present in the syngas reactor arrangement 4, in particular in the syngas reactor stage 18, on feeding to the shifting apparatus 15a-b. In other words, at least 80% of the water that is present in the shifting apparatus 15a-b in the form of steam has been fed in such a manner that it was already present in the syngas reactor arrangement 4 and subsequently became part of the syngas stream 5. Preferably at least 85%, and in particular at least 90% of the steam fraction of the syngas stream 5 is already present in the syngas reactor arrangement 4 upon feeding to the shifting apparatus 15a-b. Here, it is further preferred that at least 80%, preferably at least 85% and in particular at least 90% of the steam fraction of the syngas stream 5 originates from the condensate supplied in the saturation stage 11 upon feeding to the shifting apparatus 15a-b. As a consequence of feeding in the saturation stage 11, the corresponding fraction of water supplied is present in the syngas reactor arrangement 4 as steam.

The condensate 12 is liquid water that was recovered by condensation of gaseous water in the plant 2. The saturation stage 11 is an apparatus with which liquid water can be fed to a gas stream—in this case specifically the energy carrier stream 3—, so that the fraction of steam is increased in the respective gas stream, i.e. in this case the energy carrier stream 3. The advantage compared with a feed of high-pressure steam consists in that this high-pressure steam does not need to be generated additionally. In the present embodiment, the condensate that is preheated in the heat exchanger stages 22a-c is pumped to a pressure of 60 bar for at 260° Celsius for feeding to the saturation stage 11. The plant 2 preferably includes the saturation stage 11.

It is further preferred that during autothermal reforming a molar steam-to-carbon ratio of at least 1.5, preferably at least 1.6, more preferably a molar steam-to-carbon ratio of at least 2 and in particular a molar steam-to-carbon ratio of at least 2.4 exists in the syngas reactor arrangement 4 and in particular in the syngas reactor stage 18. The higher the molar steam-to-carbon ratio, the smaller the methane slip and the more effectively carbon monoxide can be converted into carbon dioxide in the water-gas shifting reaction.

The following table presents process parameters that are established with different molar steam-to-carbon ratios and with autothermal reforming carried out at 65 bar.

| Steam/C ratio | 1.2 | 1.6 | 2.0 | 2.4 | 2.8 | 3.0 |
|---|---|---|---|---|---|---|
| CH₄ slip % | 3.5% | 2.5% | 1.6% | 1.2% | 0.9% | 0.8% |
| Output ATR dry | | | | | | |
| CO₂ mol/mol | 0.083 | 0.095 | 0.107 | 0.118 | 0.129 | 0.134 |
| CO mol/mol | 0.230 | 0.218 | 0.206 | 0.195 | 0.183 | 0.179 |
| H₂ mol/mol | 0.651 | 0.661 | 0.668 | 0.673 | 0.677 | 0.680 |
| Spec. energy consumption | 32.22 | 32.25 | 32.25 | 32.25 | 32.25 | 32.25 |
| Carbon Recovery Rate % | 80.4 | 85.7 | 89.2 | 91.4 | 93.0 | 93.5 |
| Remaining CO₂ | 0.351 | 0.255 | 0.192 | 0.153 | 0.127 | 0.117 |
| Emission t CO₂/t NH₃ | | | | | | |

It is evident that the methane slip decreases as the steam-to-carbon ratio increases. The proportion of carbon dioxide and hydrogen also rises relative to that of carbon monoxide in the syngas. The energy consumption does increase slightly. But this is more than offset by the fact that the percentage of recovered carbon dioxide is much higher. Ultimately, in this way the CO2 emissions can be reduced by as much as ⅔.

In principle, the energy carrier stream can be fed directly to the autothermal reforming, so that the syngas stream 5 can be obtained from the autothermal reforming. This therefore means that steam reforming is not performed when the syngas stream 5 is obtained. A preferred variant of the suggested process is characterized in that the syngas reactor arrangement 4 includes a pre-reformer 13, which is preferably part of the plant 2, for splitting hydrocarbons with at least two carbon atoms into methane. In particular, the pre-reformer 13 is integrated in the process upstream of the syngas reactor stage 18. The pre-reformer 13 preferably effects adiabatic steam reforming via a nickel-based catalyst. It is further preferred that before it is fed to the saturation stage 11 the energy carrier stream 3 is fed to a desulphurisation stage 14, preferably integrated as part of the plant 2, for desulphurisation of the energy carrier stream 3. It is also preferred that obtaining the syngas stream 5 from the autothermal reforming and pre-reforming takes place in the pre-reformer 13. Accordingly, no conventional steam reforming process is implemented in order to obtain the syngas stream 5.

A further preferred variant of the suggested process is characterized in that the syngas stream 5 is fed to a multiplicity of shifting apparatuses 15a, b before it is fed to the separating arrangement 6, which apparatuses are arranged at a distance from each other for process purposes and in particular may be part of the plant 2. This means that at least one further apparatus is arranged between two shifting apparatuses 15a, b for process purposes, wherein said further apparatus is not a shifting apparatus 15a, b. In this way, it is possible to bring the syngas stream 5 from one shifting apparatus 15a, b to a differently adjusted temperature in each case for the next shifting apparatus. It is further preferred that the syngas stream 5 fed to the shifting apparatuses 15a, b undergoes a water-gas shifting reaction each of the shifting apparatuses 15a, b to react at least a part of the carbon monoxide of the syngas stream 5 with steam of the syngas stream 5 to yield carbon dioxide and hydrogen.

According to a preferred variant of the suggested process, it is provided that the water-gas shift reaction takes place in a temperature range that decreases consecutively in each of the shifting apparatus 15a, b in the process direction. In particular, it may be that the shifting apparatuses 15a, b include a HT shifting apparatus 16 for a high temperature water-gas shift reaction and a MT shifting apparatus 17 for a medium temperature water-gas shift reaction. Alternatively or additionally, it may also be that the shifting apparatuses 15a, b include a LT shifting apparatus for a low temperature water-gas shift reaction. In such a case, it is preferred that the MT shifting apparatus 17 follows the HT shifting apparatus 16 for the purpose of the process. If provided, the LT shifting apparatus may follow the MT shifting apparatus 17 for the purpose of the process.

The high temperature water-gas shift reaction takes place at a temperature between 300 °C and 450 °C. The medium temperature water-gas shift reaction takes place at a temperature between 220 °C and 270 °C. The low temperature water-gas shift reaction takes place at a temperature between 180 °C and 250 °C. It is true that the high temperature water-gas shift reaction has a reaction equilibrium that is less favourable for the conversion into CO2, but the reaction speed is better. The high molar steam-to-carbon ratio improves the reaction equilibrium. This cascade arrangement of the shifting apparatuses initially enables rapid decomposition of carbon monoxide, wherein the following stages successively convert the remaining carbon monoxide residues. Since the concentration of the carbon monoxide has already been lowered, a longer reaction time is acceptable.

According to a preferred variant of the suggested process, it is provided that upon feeding to a first shifting apparatus 15a of the shifting apparatuses 15a, b for process purposes, at least 90% of a steam fraction of the syngas stream 5 originates from the condensate supplied in the saturation stage 11. This then makes it possible to substantially omit the supply of steam to achieve the desired steam fraction. For more precise control of the steam-to-carbon ratio, high pressure steam feed apparatuses 19a-c may be provided along the process chain. These may supply smaller quantities of steam.

A preferred variant of the suggested process is characterized in that the syngas stream 5 is fed to a condensation stage 20 to obtain process condensate 21 before feeding to the separating arrangement 6, preferably downstream of the shifting apparatuses 15a, b for process purposes. The condensation stage 20 is preferably part of the plant 2. The syngas stream 5 is preferably fed to the condensation stage 20 downstream from the shifting apparatuses 15a, b for process purposes. In other words, the condensation stage 20 is located downstream of the shifting apparatuses 15a, b for process purposes. It is further preferred that the condensate 12 supplied in the saturation stage 11 includes the process condensate 21 obtained in the condensation stage 20, or even that the in condensate 12 supplied in the saturation stage 11 substantially consists of the process condensate 21 obtained in the condensation stage 20. It is particularly advantageous if enough process condensate 21 is obtained in the condensation stage 20 so that upon feeding to the shifting apparatus 15a-b at least 80%, preferably at least 85% and in particular at least 90% of the steam fraction of the syngas stream 5 originates from the process condensate 21. If there are a plurality of shifting apparatuses 15a-b present, this preferably applies the first shifting apparatus 15a of the shifting apparatuses 15a-b in the process. The effect of having such a high fraction is that the process condensate 21 is transported substantially entirely in a circuit.

A further preferred variant of the suggested process is characterized in that before feeding to the adsorption apparatus 6, preferably upstream of the condensation stage 20, the syngas stream 5 is fed to a multiplicity of heat exchanger stages 22a-c to cool the syngas stream down. The heat exchanger stages 22a-c are preferably incorporated in the plant 2. In this way, the syngas stream 5 may be cooled to increase the yield of process condensate 21. The heat exchanger stages 22a-c are preferably arranged at a distance from each other for process purposes. In particular, the heat exchanger stages 22a-c may be arranged at least partly between the shifting apparatuses 15a-b for process purposes. The variant in which a first heat exchanger stage 22a is arranged downstream of the syngas reactor arrangement 4 in the process and upstream of the shifting apparatuses 15a, b in the process has proven to be particularly advantageous. The first heat exchanger stage 22a for the purpose of the process is understood to be the heat exchanger stage the syngas stream 5 reaches first after it leaves the syngas reactor arrangement 4.

In this way, the temperature of the syngas stream 5 can be lowered, and in particular set to exactly the optimum temperature value, even before it reaches the first shifting apparatus 15a. In general, after the water-gas shift reactions are completed, the temperature of the syngas stream 5 should be lowered to ensure the most extensive condensation possible.

According to a preferred variant of the suggested process, it is provided that the process condensate 21 is fed as coolant to at least some of the heat exchanger stages 22a-c, and preferably to all heat exchanger stages 22a-c. In particular, by this means the process condensate 21 can be preheated by at least some, and preferably by all heat exchanger stages 22a-c. Consequently, this also enables the condensate 12 fed in the saturation state 11 to be preheated. It is further preferred that the process condensate 21 is fed consecutively to the heat exchanger stages 22a-c and then to the saturation stage 11. At the same time, the heat exchanger stages 22a-c are preferably configured so that no condensation of water from the syngas stream 5 takes place in the first heat exchanger stage 22a of the process, so the first heat exchanger stage 22a remains free from condensation.

In principle, the separating arrangement 6 can be operated with any degree of separation efficiency. A preferred variant of the suggested process is characterized in that the separating arrangement 6 has a separation efficiency of not more than 90%, with the result that a molar fraction of not more than 90% of the hydrogen from the syngas stream 5 is contained in the hydrogen stream 7. Accordingly, up to 10% of the molar fraction of hydrogen in the syngas stream 5 may be contained in the waste gas stream 8. This consequently increases the substance fraction in the waste gas stream 8, which can be used for combustion without CO2 emission. This will be described later. The separating arrangement 6 preferably has a separation efficiency of not more than 85% or even not more than 80%, so that no more than a molar fraction of 85% of the hydrogen or no more than a molar fraction of 80% of the hydrogen from the syngas stream 5 is incorporated in the hydrogen stream 7. Thus, still more hydrogen is available in the waste gas stream 8 for combustion. The efficiency may be adjusted such that enough hydrogen can be made available in the waste gas stream 8 so that no additional natural gas needs to be combusted.

A preferred variant of the suggested process is characterized in that the separating arrangement 6 is operated with a substantially maximum separation efficiency, and that a newly recovered hydrogen combustion stream is used to underfire one or more fired heaters 26a-d. When the separating arrangement 6 is working with high efficiency, there will regularly not be enough hydrogen present in the waste gas stream 8 to achieve the required combustion performance. This can be supplemented by branching off hydrogen from the hydrogen stream 7.

In principle, the syngas reactor arrangement 4 may also be operated with ambient air. However, a further preferred variant of the suggested process is characterized in that an oxygen stream 23 is fed from an oxygen recovery arrangement 24 to the syngas reactor arrangement 4 to obtain the syngas stream 5. Ambient air 32 is supplied to the oxygen recovery arrangement 24. This results in a lower nitrogen fraction in the syngas stream 5. Specifically, the syngas reactor arrangement 4 obtains the syngas stream 5 from the energy carrier stream 3 through autothermal reforming with the oxygen stream 23.

According to a preferred variant of the suggested process, it is provided that at least a part of the carbon oxides from the waste gas stream 8 is fed to the syngas reactor arrangement 4 via a recovery stream 33. In this way, it is ensured however that these carbon oxides are not at first discharged directly into the atmosphere, or after combustion in the case of the carbon monoxide but instead pass through the preceding process steps again. The carbon in the recovery stream 33 can then be washed out in the carbon dioxide scrubbing apparatus described later in this document, optionally after conversion into carbon dioxide. The recovery stream 33 may be obtained from the waste gas stream 8 in various ways. According to a first variant, the recovery stream 33 is simply branched off the waste gas stream 8, so that the recovery stream 33 has substantially the same composition as the waste gas stream 8.

The recovery stream 33 may be fed in particular by feeding the recovery stream 33 to the energy carrier stream 3. In particular, it may be that the recovery stream 33 is fed to the energy carrier stream 3 upstream of a natural gas compressor 28 in the process to increase the pressure of the energy carrier stream 3. However, it is also conceivable that the recovery stream 33 is fed to the energy carrier stream 3 downstream of the natural gas compressor 28 in the process. The natural gas compressor 28 is preferably part of the plant 2.

According to a further preferred variant of the suggested process, it is provided that the separating arrangement 6 also extracts a purge stream 25, preferably containing hydrogen, from the syngas stream 5, which purge stream is used in particular for underfiring one or more fired heaters 26a-d. Such a fired heater 26a-d may also be called a “fired heater”. The purge stream 25 may also be obtained in various ways. In particular, the purge stream 25 may be extracted from the waste gas stream 8. In the present embodiment, and preferably, the recovery stream 33 and the purge stream 25 are obtained by splitting the waste gas stream 8. The one or more fired heaters 26a-d are preferably part of the plant 2.

It is also possible for the waste gas stream 8 to be fed to a pressure swing adsorption apparatus or a membrane apparatus. From the respective apparatus, the purge stream 25 may then be obtained as a stream with a higher molar hydrogen fraction, and the recovery stream 33 as a stream with a lower molar hydrogen fraction. Correspondingly, the purge stream 25 preferably also has a lower molar fraction of carbon monoxide than the recovery stream 33.

A preferred variant of the suggested process is characterized in that the efficiency of the separating arrangement 6 is set such that due to the hydrogen content of the purge stream 25 a supply stream 27a-d fed to the fired heater 26a-d is substantially free from natural gas. The supply stream 27a-d represents the gas stream that is fired in the respective fired heater 26a-d. In particular, the supply stream 27a-d may incorporate the purge stream 25 entirely or partially. The supply stream 27a-d may also consist of the purge stream 25 or of a part of the purge stream 25. With a sufficiently high hydrogen content in the purge stream 25, combustion of the hydrogen may serve to generate enough heat so that it is not necessary to combustion natural gas to achieve the desired temperature.

The plant 2 may also include a multiplicity of fired heaters 26a-d. In the present embodiment, a first fired heater 26a serves to heat the energy carrier stream 3, wherein the first fired heater 26a is arranged downstream of the natural gas compressor 28 for process purposes. The second raw material fired heater 26b also serves to heat the energy carrier stream 3 but is arranged in the process between the saturation stage 11 and the pre-reformer 13. The third fired heater 26c likewise serves to heat the energy carrier stream 3 and is arranged in the process between the pre-reformer 13 and the syngas reactor stage 18. Finally, the fourth fired heater 26d serves to heat a steam stream 29 obtained from the ammonia reactor arrangement 10.

A further preferred variant of the suggested process is accordingly characterized in that the purge stream 25 is used for underfiring a plurality of fired heaters 26a-d of the plant 2, and in particular for underfiring all fired heaters 26a-d of the plant 2. For this purpose, it may be that the respective supply stream 27 a-d is obtained from a splitting of the purge stream 25 into a multiplicity of supply streams 27a-d. This in turn enables the preferred variant, according to which as a result of the hydrogen content in the purge stream 25, the respective supply stream 27a-d supplied to all of the fired heaters 26a-d of the plant is substantially free from natural gas. It follows logically that consequently the CO2 emission from the plant 2 is substantially reduced.

According to a preferred variant of the suggested process, it is provided that the syngas stream 5 is fed to a carbon dioxide scrubbing apparatus 30 arranged downstream of the shifting apparatus 15a-b in the process in order to wash at least some of the carbon dioxide out of the syngas stream 5. The carbon dioxide washed out as a carbon dioxide stream 34 can then be sequestered or otherwise used, and at any rates is not inevitably emitted into the atmosphere. In particular, it is provided that in the carbon dioxide scrubbing apparatus 30 the carbon dioxide is washout with a scrubbing medium containing methanol.

The suggested plant is used in the production of ammonia 1 and includes a syngas reactor arrangement 4 for obtaining a syngas stream 5 with hydrogen and carbon oxides from a carbon-containing energy carrier stream 3 via autothermal reforming. The heat necessary for the endothermal reforming reactions is provided by a preferably catalytic partial oxidation.

The suggested plant further includes a shifting apparatus 15a-b, to which the syngas stream 5 is fed, wherein a water-gas shift reaction takes place in the shifting apparatus 15a-b to react at least part of the carbon monoxide of the syngas stream 5 with steam from the syngas stream 5 to yield carbon dioxide and hydrogen.

The suggested plant further includes a separating arrangement 6 arranged downstream of the shifting apparatus 15a-b in the process for separating at least part of the syngas stream 5 into a hydrogen stream 7 with hydrogen and a waste gas stream 8 containing carbon oxides, and an ammonia reactor arrangement 10 for converting at least a part of a hydrogen stream 7 and a nitrogen stream 9 into ammonia 1.

The suggested plant is characterized in that the plant 2 has a saturation stage 11 arranged upstream of the syngas reactor arrangement 4 in the process for feeding condensate 12 arising in the plant 2 to the energy carrier stream 3.

The suggested plant is further characterized in that upon feeding to the shifting apparatus 15a-b at least 80% of a steam fraction of the syngas stream 5 is already present in the syngas reactor arrangement 4.

The preferred variants, features and properties of the suggested process as described in the preceding text correspond to preferred variants, features and properties of the suggested plant, and vice versa.

1.-16. (canceled)

17. A method for producing ammonia in a plant, the method comprising:
feeding a carbon-containing energy carrier stream to a syngas reactor arrangement of the plant for obtaining a syngas stream with hydrogen and carbon oxides, wherein the syngas reactor arrangement obtains the syngas stream from the energy carrier stream by autothermal reforming;
feeding the syngas stream to a shifting apparatus of the plant, wherein a water-gas shift reaction takes place in the shifting apparatus to react at least a part of carbon monoxide of the syngas stream with steam from the syngas stream to yield carbon dioxide and hydrogen;
feeding at least part of the syngas stream to a separating arrangement of the plant downstream of the shifting apparatus for separating the syngas stream at least into a hydrogen stream with hydrogen and a waste gas stream containing carbon oxides; and
feeding at least a part of the hydrogen stream and a nitrogen stream to an ammonia reactor arrangement to convert into the ammonia, wherein, prior to feeding the energy carrier stream to the syngas reactor arrangement, feeding the energy carrier stream to a saturation stage of the plant,
wherein, in the saturation stage, preheated condensate, from the plant is fed to the energy carrier stream, and
wherein at least 80% of a steam fraction of the syngas stream is already present in the syngas reactor arrangement for feeding to the shifting apparatus.

18. The method according to claim 17, wherein the syngas reactor arrangement comprises a pre-reformer for splitting hydrocarbons with at least two carbon atoms into methane.

19. The method according to claim 17, wherein, prior to feeding the syngas stream to the separating arrangement, the syngas stream is fed to a plurality of shifting apparatuses, and wherein a water-gas shift reaction takes place in each of the shifting apparatuses to react at least a part of the carbon monoxide in the syngas stream with the steam in the syngas stream, yielding the carbon dioxide and the hydrogen.

20. The method according to claim 19, wherein the water-gas shift reaction takes place in each of the shifting apparatuses in a temperature range that decreases in a direction of the method.

21. The method according to claim 17, wherein feeding the syngas stream to the plurality of shifting apparatuses comprises feeding the syngas stream to a first shifting apparatus of the shifting apparatuses, and wherein at least 80%, of a steam fraction of the syngas stream originates from the condensate supplied in the saturation stage.

22. The method according to claim 17, wherein, prior to feeding the syngas stream to the separating arrangement, feeding the syngas stream to a condensation stage for obtaining process condensate.

23. The method according to claim 17, wherein, prior to feeding to the syngas stream to the separating arrangement, feeding the syngas stream to a plurality of heat exchanger stages for cooling the syngas stream.

24. The method according to claim 17, wherein, in an autothermal reforming in the syngas reactor arrangement, a molar steam-to-carbon ratio of at least 1.6 exists.

25. The method according to claim 17, wherein the separating arrangement has a separation efficiency not more than 90%, so that not more than a molar fraction of 10% of the hydrogen from the syngas stream is incorporated in the hydrogen stream.

26. The method according to claim 17, wherein the separating arrangement is operated with a maximum separation efficiency, and wherein t a newly recovered hydrogen combustion stream is used to under-fire one or more gas-fired raw material heaters.

27. The method according to claim 17, further comprising feeding an oxygen stream from an oxygen recovery arrangement to the syngas reactor arrangement to obtain the syngas stream.

28. The method according to claim 17, wherein at least a part of the carbon oxides from the waste gas stream is fed to the syngas reactor arrangement via a recovery stream.

29. The method according to claim 17, wherein the separating arrangement also obtains a purge stream from the syngas stream, which is used in for under-firing a gas-fired raw material heater.

30. The method according to claim 29, wherein an efficiency of the separating arrangement is adjusted such that, based on a hydrogen content of the purge stream, a supply stream fed to the raw gas-fired material heater is substantially free from natural gas.

31. The method according to claim 17, further comprising feeding the syngas stream to a carbon dioxide scrubbing apparatus downstream of the shifting apparatus for at least partially washing the carbon dioxide out of the syngas stream.

32. A plant for producing ammonia comprising:
a syngas reactor arrangement configured to obtain a syngas stream with hydrogen and carbon oxides from a carbon-containing energy carrier stream y autothermal reforming;
a shifting apparatus configured to receive the syngas stream, wherein a water-gas shift reaction takes place in the shifting apparatus to react at least a part of carbon monoxide of the syngas stream with steam from the syngas stream to yield carbon dioxide and hydrogen;
a separating arrangement positioned downstream of the shifting apparatus, the separating arrangement configured to separate at least a part of the syngas stream into a hydrogen stream with hydrogen and a waste gas stream containing carbon oxides;
an ammonia reactor arrangement configured to convert at least a part of the hydrogen stream and a nitrogen stream into the ammonia; and
a saturation stage arranged upstream of the syngas reactor arrangement, wherein the saturation stage is configured to feed preheated condensate from the plant to the energy carrier stream, and wherein at least 80% of a steam fraction of the syngas stream is already present in the syngas reactor arrangement for feeding to the shifting apparatus.
